(19) United States
(12) Patent Application Publication
(10) Pub. No.: US 2006/0159965 A1
(43) Pub. Date: Jul. 20, 2006

(54) Fuel cell system and cleaning system

(76) Inventors: Kenji Kibune, Ora-Gun (JP); Hiroki Kabumoto, Saitama-City (JP); Ryoko Kubo, Ora-Gun (JP); Takashi Yasuo, Ashikaga-City (JP); Hiroko Kanai, Okegawa-City (JP)

Correspondence Address: MCDERMOTT WILL & EMERY LLP, 600 13TH STREET, N.W., WASHINGTON, DC, 20005-3096, US

(21) Appl. No.: 11/319,208

(22) Filed: Dec. 28, 2005

(30) Foreign Application Priority Data
Dec. 28, 2004 (JP) 2004-379006

(51) Int. Cl. H01M 8/04; H01M 16/00

(52) U.S. Cl. 429/12; 429/26; 429/9; 320/101

(57) ABSTRACT

A fuel cell system and a cleaning system provided with the function of cleaning cordlessly are provided. The fuel cell system includes a fuel cell which generates electric power by using liquid fuel and a cleaning apparatus which cleans a target of cleaning by using the liquid fuel. A cleaning system includes: a fuel cell which generates electric power by using liquid fuel; and a cleaning apparatus which cleans using the liquid fuel.

### BACKGROUND OF THE INVENTION

1. Field of the Invention

The present invention relates to a fuel cell system and a cleaning system and, more particularly, to a fuel cell system and a cleaning system provided with the function of cleaning using fuel used in a fuel cell.

2. Description of the Related Art

Recently, apparatuse such as that of patent document No. 1 is known in which refilling and exchange of a cleaning solution are enabled so that an object of cleaning is maintained in a clean condition.
[patent document No. 1]
National publication of the translated version of PCT application No. 2001-512338

In the cleaning apparatus listed above, however, electric power is required as a power source for a motor necessary to circulate the cleaning solution and as a power source for a fan used in a subsequent drying process. Electric power is conventionally supplied from a commercial power source via an electric cord. Accordingly, there has been a problem in that the apparatus can only be used at selected locations such as a room where commercial power is available and a vehicle provided with a power supply socket.

### SUMMARY OF THE INVENTION

A primary purpose of the present invention is to provide a fuel cell system and a cleaning system provided with the function of cleaning cordlessly.

In one embodiment of the present invention, the fuel cell system comprises a fuel cell which generates electric power by using liquid fuel and a cleaning apparatus which cleans a target of cleaning by using liquid fuel.

In one embodiment, the cleaning system comprises: a fuel cell which generates electric power by using liquid fuel; a cleaning apparatus which cleans a target of cleaning using the liquid fuel; and an electric appliance which is charged by the electric power generated by the fuel cell and which is cleaned by the cleaning apparatus. Alternatively, the cleaning system comprises: a fuel cell which generates electric power by using liquid fuel; a heater which is heated by the fuel cell; and a cleaning apparatus which is provided adjacent to the heater and which cleans a target of cleaning using the liquid fuel. Still alternatively, the cleaning system comprises: a fuel cell which generates electric power by using liquid fuel; and a cleaning apparatus which is driven by the electric power generated by the fuel cell and which cleans a target of cleaning using the liquid fuel.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic view showing the structure of a fuel cell system according to an embodiment of the present invention;

FIG. 2 is a schematic view showing an example in which the fuel cell system according to the embodiment is applied to electric tool equipment;

FIG. 3 is a schematic view showing an electric tool removed from the electric tool equipment of FIG. 2;

FIGS. 4A and 4B are schematic views showing an example in which the fuel cell system according to the embodiment is employed in a toilet; and

FIGS. 5A and 5B are schematic views showing an example in which the fuel cell system according to the embodiment is employed in heavy duty cleaning equipment.

### DETAILED DESCRIPTION OF THE INVENTION

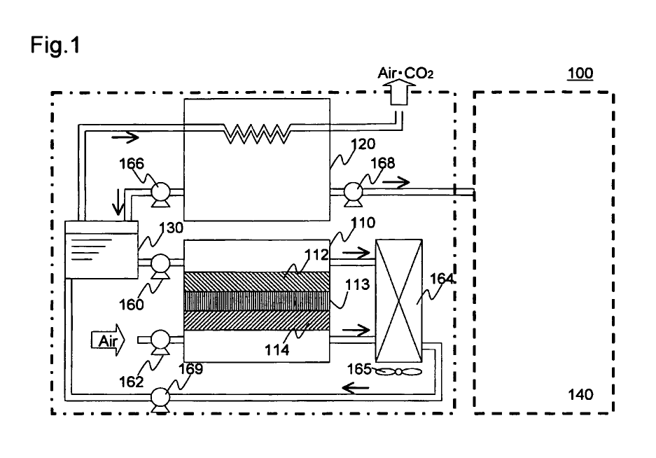

FIG. 1 is a schematic view showing the structure of a fuel cell system 100 according to an embodiment of the present invention.

The fuel cell system 100 according to the embodiment comprises: a fuel cell 110 which generated electric power by using liquid fuel; a liquid fuel tank 120 which stores the fuel of the fuel cell 110; a fuel buffer tank 130 which stores unreacted liquid fuel from the fuel cell 110 and dilutes the liquid fuel to a predetermined concentration when supplying the liquid fuel from the liquid fuel tank 120 to the fuel cell 110; a cleaning apparatus 140 which is capable of using the liquid fuel used in the fuel cell 110 as detergent or a solvent for detergent; pumps which supply fuel, oxidant, detergent and the like to the respective components; a control apparatus (not shown) which controls the operation of the fuel cell 110 and the pumps; and a heat exchanger (not shown) for heat exchange between fluids.

When the fuel cell system 100 is generating electric power in a steady-state operation, liquid fuel (organic fuel) such as isopropyl alcohol, ethylene glycol, dimethyl-ether, ethyl-alcohol, methyl alcohol or the like is diluted by the fuel buffer tank 130 to a predetermined concentration before being supplied to the anode 112 of the fuel cell 110 via a fuel supply pump 160. Air taken in from outside the system is supplied to a cathode 114 via an air supply pump 162. Electricity is generated as a result of reaction between hydrogen in the liquid fuel thus supplied and oxygen in the air. Carbon dioxide is generated at the anode 112 and water is generated at the cathode 114. The liquid fuel supplied to the anode 112 does not react completely and emitted therefrom at a lower concentration than when supplied to the anode. More specifically, a mixture of liquid fuel of reduced concentration and carbon dioxide in the gas-liquid phase is emitted from the anode 112. Oxygen concentration in the air from the cathode 114 is also lower than when the air is supplied to thereto, with the result that the cathode 114 emits a mixture of low oxygen concentration air and generated water in the gas-liquid phase.

Exhaust from the anode 112 and that of the cathode 114 are of the same temperature as the operating temperature of the fuel cell 110 (about 55° C.) . Thus, they are mixed and then introduced into the heat exchanger (radiator) 164. After heat is sufficiently dissipated, the mixture is introduced into the fuel buffer tank 130 for gas-liquid separation. Carbon dioxide and air are emitted outside the system. Liquid fuel and generated water are reused in the fuel buffer tank 130. In this way, the concentration of liquid fuel in the fuel buffer tank 130 is gradually lowered. Accordingly, the concentration of liquid fuel in the fuel buffer tank 130 is monitored at regular intervals so that the fuel buffer tank 130 is replenished with high concentration liquid fuel from the liquid fuel tank 120 by using a fuel supplying pump 166.

In the cleaning apparatus 140, liquid fuel used in the fuel cell 110 is used as detergent or a solvent for detergent. Accordingly, detergent used in the cleaning apparatus 140 is supplied from the liquid fuel tank 120 to the cleaning apparatus 140 via a detergent supplying pump 168. That is, the fuel cell 110 and the cleaning apparatus 140 share the liquid fuel tank 120 for supply of fuel and for supply of detergent, respectively. Accordingly, when the fuel cell tank 120 is empty, the supply of fuel to the fuel cell 110 and the supply of detergent to the cleaning apparatus 140 are replenished by replacing the fuel cell tank 120 or filling up the liquid fuel tank 120.

Examples of a variety of applications in which the cleaning apparatus 140 is used include: a charging and cleaning apparatus for a machine tool, a shaver, an electric tooth brush etc.; sanitary equipment for cleaning a toilet bowl or heating a toilet seat; and heavy duty cleaning equipment for cleaning the floor or outer wall of buildings, factories, etc. Some examples of applications will be explained below. The requirement for the cleaning apparatus 140 is that the liquid fuel used in the fuel cell 110 is also used as detergent or a solvent for detergent used in the cleaning apparatus 140. It will be noted therefore that the examples that follow are only illustrative.

### EXAMPLE 1

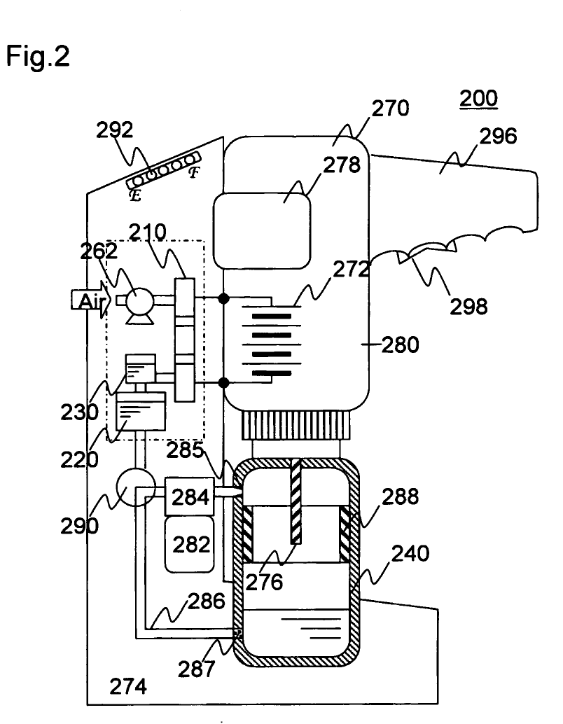

FIG. 2 shows an example in which the fuel cell system according to the embodiment is applied to cordless electric tool equipment 200. By employing the fuel cell system 100 to build an apparatus as described below which is provided with the functions of cleaning and charging, it is possible to extend the life of a rechargeable battery-powered appliance drivable by charged power in an environment in which a commercial power supply is not available. Since the cleaning function is additionally provided, the appliance is maintained in a clean and sanitized condition.

A rechargeable battery 272 such as a lithium ion battery is built in an electric tool 270 of the electric tool equipment 200 according to this example. By docking the electric tool 270 in a stand type charging and cleaning apparatus 274 after use, recharging of the rechargeable battery 272 and cleaning of a tool unit 276 are started. Electric power necessary for recharging of the rechargeable battery 272 and cleaning of the tool unit 276 is supplied from a fuel cell 210.

A holder 278 holds the electric tool 270. When the tool unit 276 of the electric tool 270 is inserted into a cleaning tank 240 of the charging and cleaning apparatus 274 and a body 280 of the electric tool 270 is fitted to a holder 278, cleaning of the tool unit 276 is started. A cleaning solution supplying 284 is driven by a motor 282 to inject a cleaning solution onto the tool unit 276 so that dirt and stain on the tool unit 276 fall off into the cleaning tank 240 together with the cleaning solution. The cleaning solution accumulated at the bottom of the cleaning tank 240 is absorbed by the cleaning solution supplying unit 284 through a cleaning solution circulating pipe 286 and injected onto the tool unit 276 again.

The tool unit 276 is cleaned more efficiently if it is rotated. Therefore, it is favorable to rotate the tool unit 276, by using electric power supplied from the fuel cell 210 in the charging and cleaning apparatus 274 or electric power supplied from a discharging circuit for discharging electric power that remains in the rechargeable battery 272. When the cleaning is completed, an electric heater 288 is started so as to dry the tool unit 276. The drying step may not depend on the electric heater 288. Alternatively, heat generated by the fuel cell 210 may be blown into the cleaning tank 240. When there remains little cleaning solution in the cleaning tank 240, a three-way valve is switched to supply isopropyl alcohol, fuel of the fuel cell 210, from the liquid fuel tank 220.

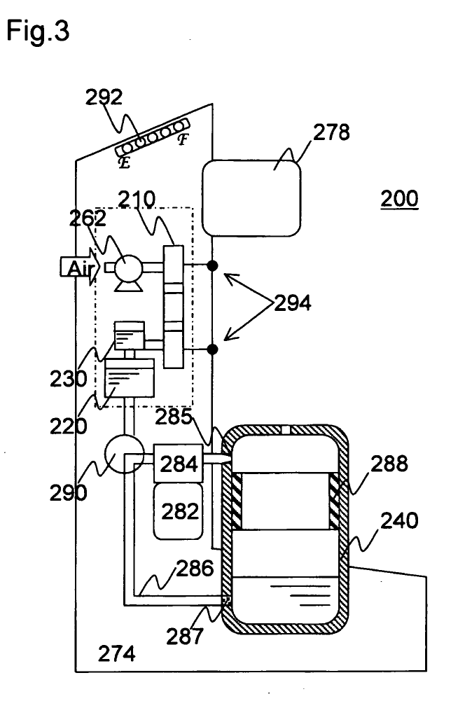

The rechargeable battery 272 is charged concurrently with the cleaning and drying steps. If it is desired that electric power that remains in the rechargeable battery 272 be discharged, the charging step is started after the discharging step is completed. The charge state (condition of electric energy in the rechargeable battery 272) of the electric tool 270 can be viewed on a display 292. When the rechargeable battery 272 is fully charged or when the electric tool 270 is removed from the charging and cleaning apparatus 274 as shown in FIG. 3, power generation by the fuel cell 210 is halted. In order to determine whether the electric tool 270 is removed from the charging and cleaning apparatus 274, the opening of the holder 278 may be monitored or the current-carrying state at points of contact between the rechargeable battery 272 and the fuel cell 210 may be monitored.

### EXAMPLE 2

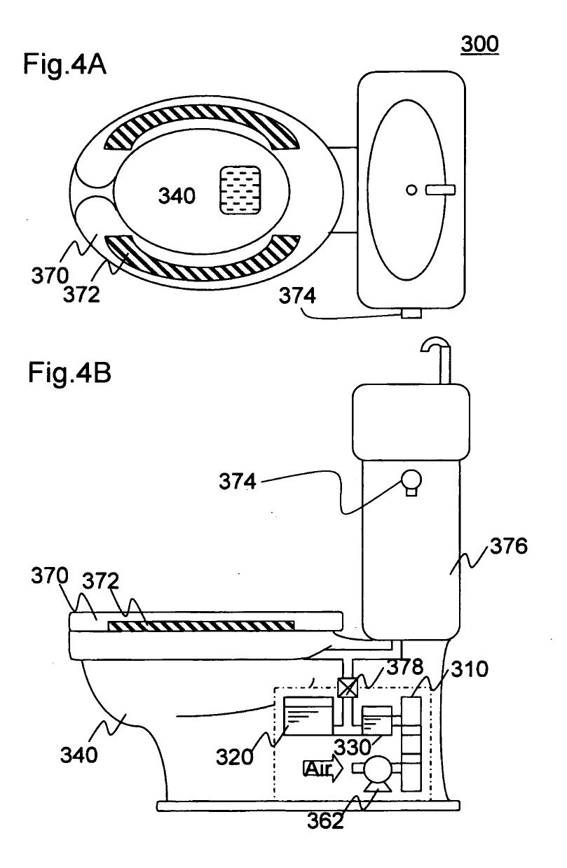

FIG. 4A (top view) and FIG. 4B (side view) show an example in which the fuel cell system according to the embodiment is employed in a toilet 300. By employing the fuel cell system 100 in the toilet 300, it is possible to keep the warmth of the interior of a portable toilet, which is used in a construction site or an emergency evacuation area, or the warmth of a toilet bowl used in the toilet. It is also possible to maintain the cleanliness of a toilet bowl.

The toilet 300 according to this example has an electric heater 372 built inside a toilet seat 370. Electric power supplied from a fuel cell 310 keeps the toilet seat 370 warm. Heating equipment or air cleaning equipment (not shown) may be provided in a space in which the toilet 300 is provided. By supplying electric power from the fuel cell 310 to the heating equipment or air cleaning equipment, it is possible to make the room in which the toilet 300 is provided a comfortable space.

A lever 374 is used to cause water for cleaning a toilet bowl 340 to be discharged out of a water tank 376 after using the toilet 300. By tilting the lever 374 toward a user or away from the user, water is drained from the water tank 376 to the toilet bowl 340 so as to flush down the toilet bowl 340. The lever 374 and a valve 378 operate in cooperation with each other such that, when the toilet bowl 340 is cleaned, isopropyl alcohol, fuel of the fuel cell 310, is supplied from a liquid fuel tank 320 as a cleaning solution. The cleaning solution may not necessarily be supplied each time the toilet bowl 376 is cleaned. The cleaning solution may be supplied only when the lever 34 is tilted toward the user (or away from the user). Alternatively, the cleaning solution may only be used once in ten times that the toilet bowl 340 is flushed down with water, irrespective of the direction to which the lever 374 is tilted. Still alternatively, timer control may be applied to perform cleaning once in a predetermined time interval.

### EXAMPLE 3

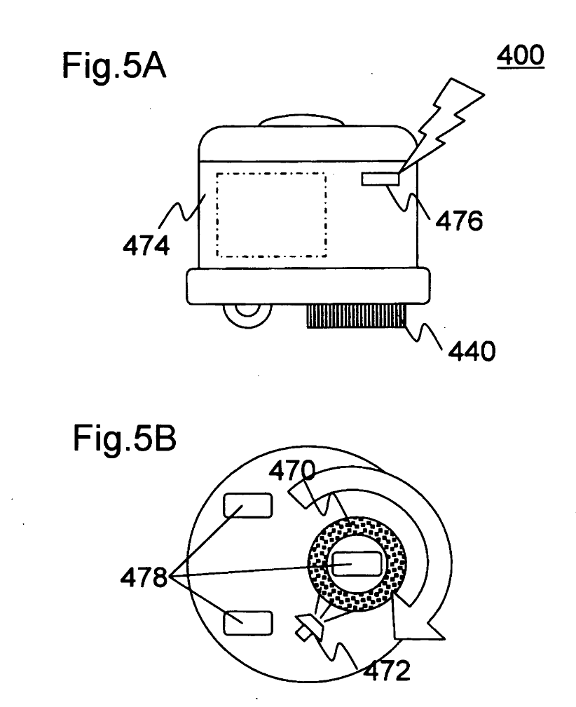

FIG. 5A (side view) and FIG. 5B (bottom view) show an example in which the fuel cell system according to the embodiment is employed in heavy duty cleaning equipment 400. By employing the fuel cell system 100 in the heavy duty cleaning equipment 400 as described below, it is possible to clean the floor and outer wall of buildings, factories, etc., or outdoor facilities like tunnels and guard rails, without worrying about a power supply.

The heavy duty cleaning equipment 400 according to this example comprises a cleaner unit 440. The cleaner unit 440 comprises a rotating brush 470 and a cleaning solution dispensing nozzle 472. The electric power supplied from a fuel cell built in a cleaner equipment main unit 474 drives the rotating brush 470 and causes the cleaning solution to be injected from the cleaning solution dispensing nozzle 472. Isopropyl alcohol, fuel of the fuel cell, may be diluted with water when supplied from a liquid fuel tank to the cleaning solution dispensing nozzle 472 if necessary.

The heavy duty cleaning equipment 400 may comprise a communication unit 476 which communicates with a managing entity for managing the heavy duty cleaning equipment 400. The heavy duty cleaning equipment 400 may be of a self-propelled type that automatically cleans selected locations in a building or a factory that need cleaning, in accordance with an instruction from the managing entity. In this process, power required by the communication unit for communication is also supplied from the fuel cell built in the cleaning equipment main unit 474.

A system in which liquid fuel is directly supplied from a liquid fuel tank to a cleaning apparatus is described above as a best mode of carrying out the invention. Alternatively, as mentioned above, the liquid fuel may be diluted with water or supplied from a fuel buffer tank to a cleaning apparatus as appropriate.

Thus, since the fuel cell system and the cleaning system according to the present invention are provided with a fuel cell and a cleaning apparatus, the cleaning function as well as the supply of electric power from the fuel cell is provided.

Described above are examples showing how the fuel cell system according to the embodiment is employed. The fuel cell system may also be employed in a cleaning apparatus or a sterilizing apparatus for medical appliances, a cleaning apparatus for use in a semiconductor fabrication process, a beverage production machine or a beverage dispensing machine. While the preferred embodiments of the present invention have been described using specific terms, such description is for illustrative purposes only, and it is to be understood that changes and variations may be made without departing from the spirit or scope of the appended claims.

What is claimed is:

1. A fuel cell system comprising:
a fuel cell which generates electric power by using liquid fuel; and
a cleaning apparatus which cleans a target of cleaning using the liquid fuel.

2. The fuel cell system according to claim 1, further comprising a fuel container which stores the liquid fuel to be supplied to the fuel cell.

3. The fuel cell system according to claim 2, wherein the fuel container is detachably provided in the fuel cell system.

4. The fuel cell system according to claim 2, wherein the fuel cell container comprises a fuel supplying unit capable of externally supplying the liquid fuel to the fuel cell container.

5. The fuel cell system according to claim 1, further comprising a first liquid fuel diluting unit which is provided at the front end of the fuel cell and which dilutes the liquid fuel to a predetermined concentration.

6. The fuel cell system according to claim 1, further comprising a gas liquid separating unit which combines anode exhaust emitted from an anode of the fuel cell and a cathode exhaust emitted from a cathode of the fuel cell and which separates gas from liquid.

7. The fuel cell system according to claim 6, wherein the gas liquid separating unit includes a cooling unit.

8. The fuel cell system according to claim 7, wherein the cooling unit comprises a first cooler which cools the anode exhaust and the cathode exhaust with externally supplied air.

9. The fuel cell system according to claim 7, wherein the cooling unit comprises a second cooler which is provided adjacent to the fuel container.

10. The fuel cell system according to claim 1, wherein the liquid fuel for cleaning the target of cleaning is supplied to the cleaning apparatus at predetermined intervals.

11. The fuel cell system according to claim 1, further comprising a second liquid diluting apparatus which is provided in the cleaning apparatus and which dilutes the liquid fuel to a predetermined concentration.

12. The fuel cell system according to claim 1, wherein the cleaning apparatus comprises: a cleaning tank into which a target for cleaning is introduced, a liquid fuel circulating circuit in which the liquid fuel is circulated; and a liquid fuel circulating unit which circulates the liquid fuel.

13. The fuel cell system according to claim 1, further comprising: a rechargeable battery which is provided in the target of cleaning and which is chargeable by external electric power; and a charging circuit which charges the battery with electric power generated by the fuel cell.

14. The fuel cell system according to claim 13, further comprising a discharging circuit which discharges the battery.

15. The fuel cell system according to claim 1, further comprising a heated apparatus which is provided adjacent to the target of cleaning and which is heated by the fuel cell.

16. The fuel cell system according to claim 15, wherein the heated apparatus is a heater which is heated by the electric power generated by the fuel cell.

17. The fuel cell system according to claim 1, wherein the cleaning apparatus comprises: a liquid fuel injecting unit which injects the liquid fuel; and a cleaner which cleans the target of cleaning by coming into contact therewith.

18. A cleaning system comprising:
a fuel cell which generates electric power by using liquid fuel;
a cleaning apparatus which cleans a target of cleaning by using the liquid fuel; and
an electric appliance which is charged or driven by the electric power generated by the fuel cell and which is cleaned by the cleaning apparatus.

19. The cleaning system according to claim 18, further comprising a fuel container which stores the liquid fuel to be supplied to the fuel cell.

20. The cleaning system according to claim 18, wherein the liquid fuel for cleaning the electric appliance is supplied to the cleaning apparatus at predetermined intervals.

21. The cleaning system according to claim 18, wherein the cleaning apparatus comprises: a cleaning tank into which the electric apparatus is introduced, a liquid fuel circulating circuit in which the liquid fuel is circulated; and a liquid fuel circulating unit which circulates the liquid fuel.

22. The cleaning system according to claim 18, further comprising a heated apparatus which is provided in the cleaning apparatus and which is heated by the fuel cell.

23. The cleaning system according to claim 22, wherein the heated apparatus is a heater which is heated by the electric power generated by the fuel cell.

24. A cleaning system comprising:
a fuel cell which generates electric power by using liquid fuel;
a heated apparatus which is heated by the fuel cell; and a cleaning apparatus which is provided adjacent to the heated apparatus and which cleans a target of cleaning by using the liquid fuel.

25. The cleaning system according to claim 24, wherein the heated apparatus is a heater which is heated by the electric power generated by the fuel cell.

26. The cleaning system according to claim 24, wherein the cleaning apparatus comprises a water tank.

27. A cleaning system comprising:
a fuel cell which generates electric power by using liquid fuel;
a cleaning apparatus which is driven by the electric power generated by the fuel cell and which cleans a target of cleaning by using the liquid fuel.

28. The cleaning system according to claim 27, wherein the cleaning apparatus comprises: a liquid fuel injecting unit which injects the liquid fuel; and a cleaner unit which cleans the target of cleaning by coming into contact therewith.

29. The cleaning system according to claim 27, further comprising a moving unit which is driven by the electric power generated by the fuel cell.

30. The cleaning system according to claim 29, further comprising a communicating unit capable of receiving an external instruction, wherein the system is moved in accordance with the instruction.
